(19) United States
(12) Patent Application Publication
(10) Pub. No.: US 2002/0083402 A1
(43) Pub. Date: Jun. 27, 2002

(54) Method and system for simulating integrated circuit designs

(76) Inventors: Yoshihito Higashitsutsumi, Gifu-ken (JP); Hironori Yagi, Tokyo (JP)

Correspondence Address: FRANK R. OCCHIUTI, Fish & Richardson P.C., 225 Franklin Street, Boston, MA, 02110-2804, US

(21) Appl. No.: 09/995,996

(22) Filed: Nov. 16, 2001

(30) Foreign Application Priority Data
Nov. 17, 2000 (JP) 2000-351248

(51) Int. Cl. G06F 17/50

(52) U.S. Cl. 716/4; 716/5

(57) ABSTRACT

A system for simulating an integrated circuit design. The system includes a database for storing functional block information, a database manager for transferring the functional block information to and from the database, an input equipment for inputting required specification information of the integrated circuit design, a simulator for simulating an integrated circuit design including at least one functional block using the functional block information and the required specification information, and a display equipment for displaying a simulation result. The simulation system enables circuit designing of a system LSI to be performed quickly and immediately.

### BACKGROUND OF THE INVENTION

The present invention relates to a method and system for simulating an integrated circuit design. More particularly, the present invention pertains to a method and a system for simulating a system integrated circuit that is configured based on information of functional blocks (hereafter referred to as circuit intellectual property, or IP), which are based on modules of hardware defined in functional units or software associated with the modules of hardware.

Due to the higher concentration and larger size of recent large-scale integrations (LSIs), it takes more time to design an LSI, the number of bugs have increased, and it takes more time for a product to enter the market. Further, since an LSI may include a tremendous amount of devices, it is important that the basic concept of an LSI such as what to achieve with the LSI be clarified.

The LSI is presently designed in combination with IP, which is a module defined as a functional unit, to achieve the required functions. Such procedure for designing an LSI has become popular.

In the prior art, the procedure for designing a system LSI, which uses IP as a basic unit, has been performed in the following manner.

(a) A salesman of an LSI maker visits a customer, or LSI user (e.g., equipment maker), and obtains information for the specification of an LSI in accordance with the user's requirements. The salesman then returns to his office with the required specification.

(b) The salesman hands the required specification to an LSI designer so that the designer can review the specification. The designer determines the feasibility of the required specification and the size of the LSI would be.

(c) When the designer completes the review and informs the salesman of the results, the salesman explains the results to the user.

Such procedure is repeatedly performed.

The employment of such system LSI designing procedure, which uses IP as a basic unit, has facilitated the designing of an LSI and enabled simulations to be performed flexibly.

However, in the conventional system LSI designing procedure, it takes time to obtain the required specification and determine the feasibility and size of an LSI. Thus, it is difficult to give a quick reply to a user.

### SUMMARY OF THE INVENTION

It is an object of the present invention to provide a method and system for simulating an integrated circuit design that facilitates and shortens the time for circuit designing a system LSI, which uses IP as a basic unit.

To achieve the above object, the present invention provides a method for simulating an integrated circuit design. The method includes acquiring information of functional blocks, storing the information of the functional blocks in a storing device of a computer, simulating the integrated circuit design including at least one of the functional blocks using the information of the functional blocks, and outputting a simulation result to an outputting device. The step for acquiring the information of the functional blocks or the step for outputting the simulation result is performed with a communication line.

A further aspect of the present invention is a system for simulating an integrated circuit design. The system includes a functional information storing device for storing functional block information. A functional information inputting/outputting device transfers the functional block information to and from the functional information storing device. A required specification information inputting device inputs required specification information of the integrated circuit design. A simulation performing device receives the functional block information from the functional information inputting/outputting device, receives the required specification information from the required specification information inputting device, and simulates the integrated circuit design, which includes at least one functional block, using the functional block information and the required specification information. An outputting device outputs a simulation result of the simulation performing device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing an integrated circuit design simulation system according to a first embodiment of the present invention;

FIG. 2 is a flowchart illustrating an integrated circuit design simulation procedure according to the present invention;

FIG. 3(a) is a chart illustrating the input of a required specification, and

FIG. 3(b) is a chart illustrating a simulation result;

FIG. 4 is a schematic block diagram showing an integrated circuit design simulation system according to a second embodiment of the present invention; and

FIG. 5 is a schematic diagram showing an integrated circuit design simulation system according to a third embodiment of the present invention.

### DETAILED DESCRIPTION OF THE PREFERRED EMBODIMENTS

In the drawings, like numerals are used for like elements throughout.

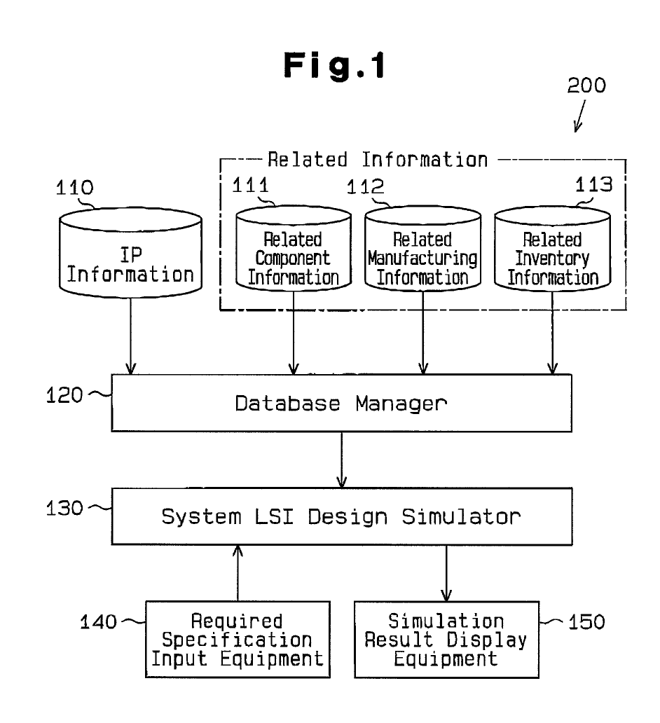

An integrated circuit (system LSI) design simulation method and simulation system 200 according to a preferred embodiment of the present invention will now be described with reference to FIGS. 1 to 3.

FIG. 1 is a schematic block diagram of the simulation system 200, which simulates a system LSI design. The basic unit of the system LSI design is IP, or information of functional blocks, which are based on modules of hardware defined in functional units or software associated with the modules of hardware.

The system LSI design simulation system 200 includes an IP information database 110, a related component information database 111, a related manufacturing information database 112, a related inventory information database 113, a database (DB) manager 120, a system LSI design simulator 130, a required specification input equipment 140, and a simulation result display equipment 150.

The IP information database 110 serves as a functional information storing device and stores multiple pieces of IP information, which is required by the system LSI and which is in demand. The IP information is stored in compliance with a single standard to enable simulation using a combination of a plurality of IPs associated with a plurality of suppliers. The IP information is updated periodically, for example, every week, every month, or whenever new information is registered.

The related component information database 111 serves as a functional information storing device and stores component information of components associated with each IP registered in the IP information database 110. The component information includes, for example, information related to a lens of a CCD camera, and is updated periodically, for example, every week, every month, or whenever new information is registered.

The related component information database 111, the related manufacturing information database 112, and the related inventory information database 113 serve as a related information storing device. The related manufacturing information database 112 stores information indicating the manufacturing status of the components associated with each IP. The related inventory information database 113 stores information indicating the stock of the components associated with each IP. The information indicating the manufacturing status and the stocking status is generated by editing information of each component that is obtained through queries sent to systems, such as a manufacturing plant and a warehouse. Such information is updated periodically, for example, every day or every week. When a query for the manufacturing information or stock information of a component cannot be sent, data indicating that there is no information may be input or data of the manufacturing information or stock information is manually input.

The DB manager 120 serves as a functional information inputting/outputting device or a related information inputting/outputting device and manages the IP information database 110, the related component information database 111, the related manufacturing information database 112, and the related inventory information database 113. The DB manager 120 accesses the databases to save and retrieve information when necessary.

An operator uses the input equipment 140 to input the required specification of a system LSI. Based on the input required specification, the simulator 130 performs a simulation to hypothetically check the feasibility and size of the system LSI. The simulator 130 displays the simulation result on the display equipment 150.

In the preferred embodiment, the simulation system 200 is installed in a portable computer so that when a salesman of an LSI maker visits a user, the salesman can evaluate on the spot the feasibility and size of a system LSI that is in accordance with the user's required specification.

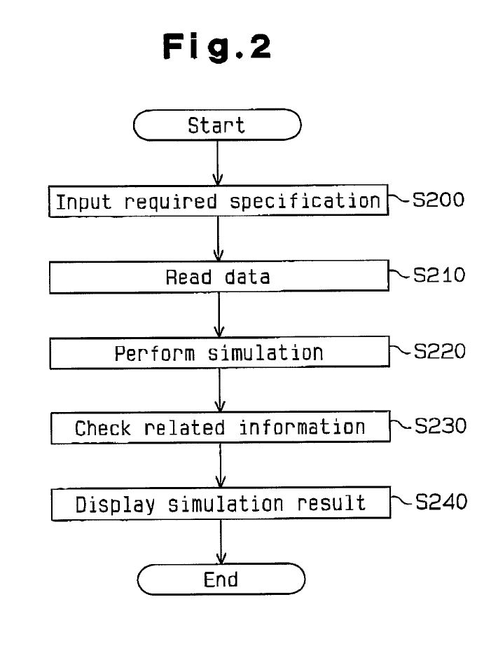

FIG. 2 is a flowchart illustrating the procedure for simulating a system LSI design with the simulation system 200.

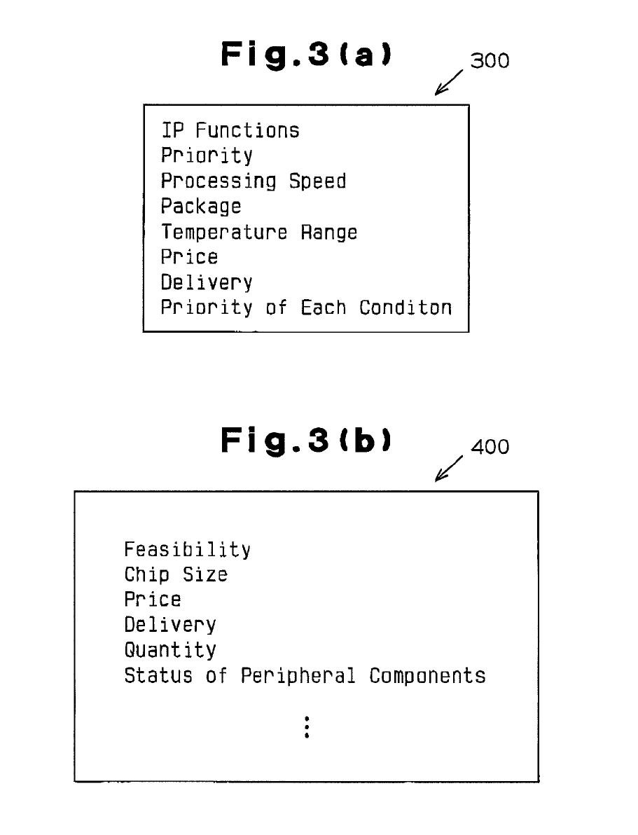

The operator first inputs a required specification with the input equipment 140, which includes a keyboard and a mouse (step S200). Referring to FIG. 3(a), the input items include functions required by the system LSI, priority of the functions, processing speed, temperature range, package, price, delivery, and priority of each condition. When the input of the required specification is completed, the simulator 130 requests the DB manager 120 for the data that is necessary to perform a simulation based on the input required specification. In response to the request, the DB manager 120 reads data from the related component information database 111, the related manufacturing information database 112, and the related inventory information database 113 (step S210) The simulator 130 then performs a simulation based on the data read in step S210 (step S220). The simulation checks whether IPs can be connected to one another, that is, whether the system LSI is feasible, which is most important when designing a system LSI. When the simulation result indicates that the system LSI is presently not feasible, an alternative system may be proposed taking into consideration the priority of the required functions. One or more alternative systems may be proposed. The number of alternative proposals may also be designated when inputting the required specification (step S200). The simulator 130 calculates the size, price, and delivery of the feasible system LSI based on the data read in step S210. At this point, when all of the conditions are not satisfied, an alternative system is proposed based on the priority of the designated conditions.

Then, the simulator 130 checks the price and delivery of the peripheral components for each IP used in the presently simulated system LSI based an the data read in step S210 (step S230).

By performing such simulations, the approximate size of the system LSI, the required peripheral components, and the availability of the peripheral components are checked. Further, the development completion time, size, and price of the product manufactured by the user may be roughly predicted.

The simulator 130 displays the simulation results obtained in steps S220 and S230 on a display of the display equipment 150. As shown in FIG. 3(b), the simulation result includes the feasibility, size, price, delivery, quantity, and status of the peripheral portions.

To perform the simulation again, the procedure is started from the input of the required specification (step S200).

The system LSI design simulation system 200 of the preferred embodiment has the advantages described below.

(1) A person that does not have the expertise to design a system LSI may immediately and accurately provide an estimate that includes the feasibility, size, price, delivery, and quantity of the required LSI. Thus, a salesman can negotiate with a system LSI designer on the spot at the user's facility while simulating an LSI design.

(2) The simulation system 200 proposes an optimal system, which includes necessary components and peripheral components in addition to a system LSI, for a product developed by a user.

(3) The approximate delivery of the necessary components, which include peripheral components, is checked. Thus, a schedule for developing the user's product may be proposed.

(4) The employment of the same database enhances the standardization of the registered IP and system LSI. Further, the standardized IP and LSI decreases component cost and increases the reliability of the product.

It should be apparent to those skilled in the art that the present invention may be embodied in many other specific forms without departing from the spirit or scope of the invention. Particularly, it should be understood that the present invention may be embodied in the following forms.

(a) The related component information database 111, the related manufacturing information database 112, and the related inventory information database are not necessarily required. As long as the IP information database 110 is provided, the feasibility, size, and price of the system LSI obtained by combining IPs are obtained by performing a simulation.

(b) Instead of configuring a simulation system in a single computer, a system that communicates with other computers in a network may be configured by employing a communication interface including the elements shown in FIG. 1.

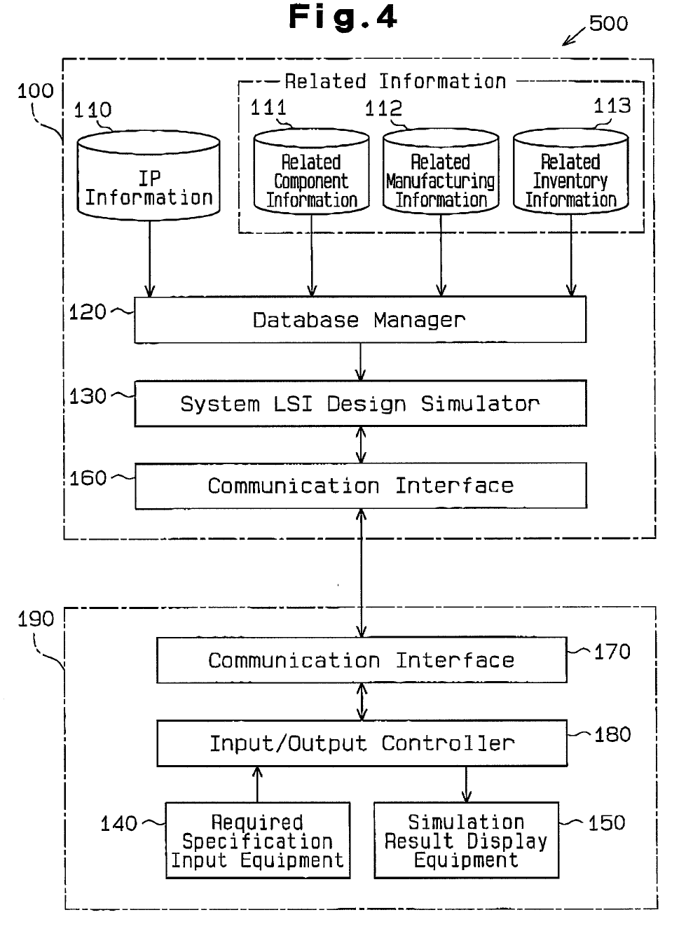

FIG. 4 is a schematic block diagram showing a client-server simulation system 500. The simulation system 500 includes a server 100 and a client 190. The server 100 has the simulator 130, the DB manager 120, the databases 110-113, and a communication interface 160. The client 190 has the input equipment 140, the display equipment 150, a communication interface 170, and an input/output controller 180. The server 100 and client 190 transfer data between each other through the communication interfaces 160, 170.

The server 100 may be connected to the Internet. In other words, the server 100 functions as an Internet server and is accessed through the Internet by an external device. In such configuration, any terminals connected with the Internet can use the simulation system. If the server 100 is frequently accessed, a standardized IP database, which can be used by all of the makers using the database, may be configured. Further, when the standardization of the IP database is enhanced, a superior system LSI may be registered in the database. In such case, if the required specification is satisfied, the registered system LSI may be used as the simulation result.

In the client-server system, the simulator 130, the DB manager 120, and the databases 110-113 do not necessarily have to be included in the same computer. In other words, the simulator 130, the DB manager 120, and the databases 110-113 may be included in different computers and connected through a communication device.

The client 190 is embodied in a portable terminal, which includes a cellular phone, a personal handyphone system (PHS), or a portable terminal, which is formed by a portable computer and a communication device. The client 190 may also be embodied in a FAX machine. In such case, an automatic response system using a tone signal from a cellular phone, a PHS, or a FAX may be employed. Alternatively, a web site for a cellular phone and a PHS may be accessed through the Internet.

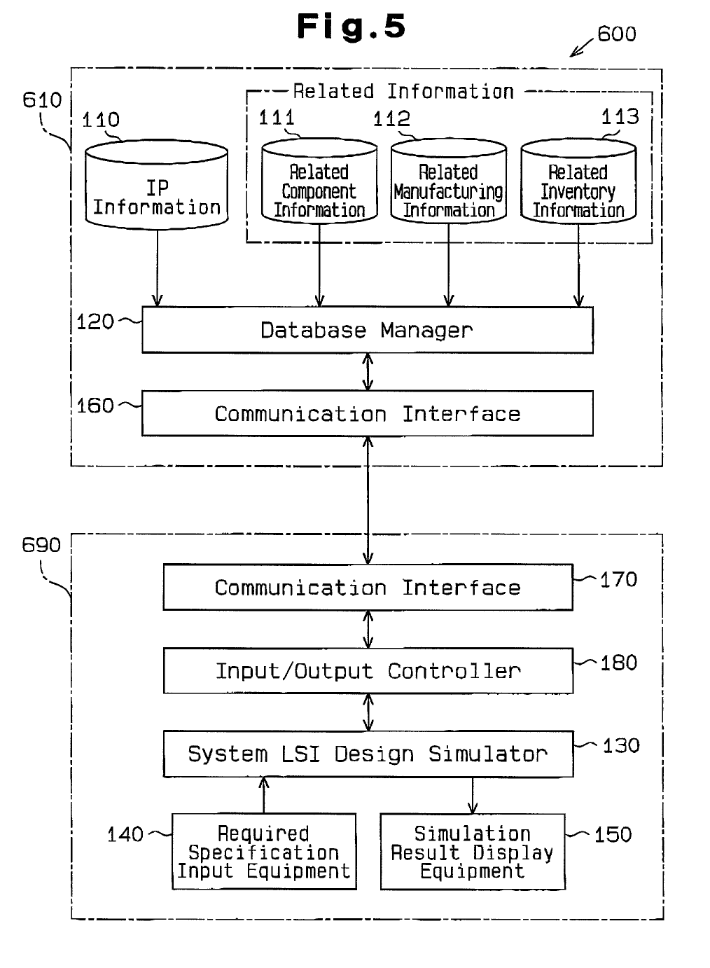

Further, the present invention may be embodied in a simulation system 600 as shown in FIG. 5. The simulation system 600 includes a server 610 and a client 690. The server 610 has the databases 110-113, the DB manager 120, and the communication interface 160. The client 690 has the simulator 130, the input equipment 140, the display equipment 150, the communication interface 170, and the input/output controller 180. The client 690 is embodied in a portable terminal, which includes a cellular phone, a PHS, or a portable terminal, which includes a portable computer and a communication device. The client 690 receives the necessary information from the server 610 through a communication line such as the Internet, performs a simulation, and outputs the simulation result.

(c) In the present invention, each of the databases 110-113 does not have to locally exist and be periodically updated. When the simulation system is connected to the network, some or all of the databases may exist outside the server 100. Further, the databases may be separated from one another. In such case, the DB manager 120 accesses the separated databases with an appropriate device through a communication line such as the Internet. The IP information of company A may be stored in server X, and the IP information of company B may be stored in server Y. In such case, it is preferred that the data structure and data form in each database be the same. If the data structure and data form is not the same, data may be converted into the same structure and form by providing the DB manager 120 or the simulator 130 with a data converting function. In such system, updated information can always be referred to by updating each of the separated databases. This facilitates the centralized managing of information by the server 100. Centralized managing of the databases with the server standardizes the registered information so that the simulation system of the present invention may be widely used.

(d) The storing device, which stores information such as IP information, is not limited to a database and may be configured by a file and a device that accesses the file.

(e) An output device including a printing device, such as a printer, or a sound outputting device, such as a speaker, may be used in lieu of the display equipment 150.

The present examples and embodiments are to be considered as illustrative and not restrictive, and the invention is not to be limited to the details given herein, but may be modified within the scope and equivalence of the appended claims.

What is claimed is:

1. A method for simulating an integrated circuit design, the method comprising the steps of:
acquiring information of functional blocks;
storing the information of the functional blocks in a storing device of a computer;
simulating the integrated circuit design including at least one of the functional blocks using the information of the functional blocks stored in the storing device; and
outputting a simulation result to an outputting device; wherein the step for acquiring the information of the functional blocks or the step for outputting the simulation result is performed with a communication line.

2. The method according to claim 1, further comprising a step for acquiring required specification information of an integrated circuit, which is subjected to design, wherein the simulating step includes simulating the integrated circuit design based on the required specification information.

3. The method according to claim 2, wherein at least one of the step for inputting required specification information, the step for acquiring information of functional blocks, and the step for outputting a simulation result is performed with a communication line.

4. The method according to claim 3, wherein the step for inputting required specification information and the step for acquiring information of functional blocks are performed with a portable communication terminal and the communication line, and the step for outputting the simulation result is performed with the portable communication terminal.

5. The method according to claim 4, wherein the communication line is the Internet and the step for inputting required specification information and the step for acquiring information of functional blocks are performed with a portable communication terminal, the Internet, and an Internet server.

6. A system for simulating an integrated circuit design, the system comprising:
a functional information storing device for storing functional block information;
a functional information inputting/outputting device for transferring the functional block information to and from the functional information storing device;
a required specification information inputting device for inputting required specification information of the integrated circuit design;
a simulation performing device for receiving the functional block information from the functional information inputting/outputting device, for receiving the required specification information from the required specification information inputting device, and for simulating the integrated circuit design, which includes at least one functional block, using the functional block information and the required specification information; and
an outputting device for outputting a simulation result of the simulation performing device.

7. The system according to claim 6, further comprising:
a communicating device for performing through a communication line at least one of transferring the required specification information from the required specification information inputting device to the simulation performing device, transferring the functional block information from the functional information inputting/outputting device to the simulation performing device, and transferring a simulation result from the simulation performing device to the outputting device.

8. The system according to claim 7, wherein the required specification information inputting device and the outputting device are included in a portable communication terminal.

9. The system according to claim 8, wherein the communication line is the Internet, and the functional information storing device and the simulation performing device are included in an Internet server.

10. The system according to claim 6, wherein the system further comprises:
a related information storing device for storing related information of the functional block information, wherein the simulation performing device generates design-related information, which is related with the integrated circuit design, based on the related information.

11. The system according to claim 10, wherein the related information storing device includes at least one of a device for storing information related with a related component of the functional block, a device for storing information related with a manufacturing schedule of the related component, and a device for storing information related with a stored quantity of the related component.

12. The system according to claim 10, further comprising a communicating device for transferring the related information from the related information storing device to the simulation performing device and/or transferring the design-related information from the simulation performing device to the outputting device through a communication device.
